(19) United States
(12) Patent Application Publication
(10) Pub. No.: US 2003/0104157 A1
(43) Pub. Date: Jun. 5, 2003

(54) Safety tiles for paving a playground area

(76) Inventors: David Frank Brady, West Yorkshire (GB); Desmond Richard Robin Sutcliffe, West Yorkshire (GB)

Correspondence Address: Monty L Ross, Locke Liddell & Sapp, Suite 2200, 2200 Ross Avenue, Dallas, TX, 75201-6776, US

(21) Appl. No.: 10/182,862

(22) PCT Filed: Jan. 31, 2001
(86) PCT No.: PCT/GB01/00388

(30) Foreign Application Priority Data
Feb. 2, 2000 (GB) 0002391.1

(51) Int. Cl. B32B 3/10

(52) U.S. Cl. 428/60; 428/44; 428/166

(57) ABSTRACT

A safety tile (1) is for use with other like tiles in paving a playground area and is made of a resilient polymeric material. A multiplicity of tongues (12) of said polymeric material project from the periphery of said layer (3), the tongues being spaced apart so as to define gaps (14) therebetween for receiving the tongues of adjacent like safety tiles. A respective through passageway (16) is provided in each tongue (12), running substantially parallel to the first face (5), and so located that the passageway in a tongue of an adjacent like tile, when the last-mentioned tongue is received in one of said gaps, aligns with the passageways of the tongues next to the said one of said gaps to permit the insertion of an elongate member (20) through said aligned passageways.

This invention relates to safety tiles for use with other like tiles in paving a playground area.

In the last twenty to thirty years, there has been considerable concern about the need to avoid or reduce injuries in children's playgrounds. One area that has received attention is the provision of resilient surfacing so that if a child falls from a swing or slide, the resilient surfacing absorbs a substantial part of the impact of the fall and reduces injury.

One known way of providing resilient surfacing was to make a rubber-based liquid mix on site, pour it into place and allow it to set. That approach had the advantage of providing a continuous surface but the disadvantages that it was difficult to control the quality of the mix on site, and that the finished surface was prone to vandalism and very difficult to repair without complete replacement if a part only of the surface became worn.

Another way of providing resilient surfacing was to mould rubber tiles in the factory and lay them side-by-side on the site. Factory production allowed better quality control than the method of mixing and pouring on site but it was exceedingly difficult or impossible to mount the tiles so that they stayed in place for years and always presented a level surface to walk or run on. In particular, thermal expansion arising from extremes of weather conditions caused irregularities of level and gaps to appear in the surfacing provided by the tiles. Such irregularities and gaps were themselves capable of causing accidents by tripping children running about the playground.

Various attempts were made to ensure that safety tiles remained stably in position but had disadvantages and/or were unsuccessful.

One approach was to make the tiles of a very heavy construction but that had the disadvantage that the amount of rubber involved made the tiles very expensive.

Another approach was to secure the tiles to a substrate and to each other by means of an adhesive but the adhesive bonds tended to weaken and fail in time and expensive substrate preparation was required.

Yet another approach was to interlock the tiles with each other in the same maimer as jigsaw puzzle pieces interlock but, as with jigsaw puzzle pieces, the interlocking did not prevent vertical misalignment.

Still yet another approach was to provide special fixings at defined points either fixing one tile to another or each tile to the substrate but that had the disadvantage that the special fixings created spots at which the surfacing was less safe. It was more dangerous to fall on a fixing than on the remainder of the safety tiling.

It is an object of the invention to provide a safety tile for use with other like tiles in paving a playground area, the tile being capable of resisting vandalism, and capable of providing, with adjacent like tiles, a level surface which remains stable over prolonged use and capable of providing a substantially uniform safety characteristic over its whole area.

The present invention provides a safety tile for use with other like tiles in paving a playground area, the tile being made of a resilient polymeric material and comprising:

a layer of the polymeric material having a first face defining a surface for walking on and a second, opposite, face;

an impact-absorbing structure of the polymeric material projecting from the said second face and terminating in a substrate-engagement face;

a multiplicity of tongues of said polymeric material projecting from the periphery of said layer, said tongues being spaced apart so as to define gaps therebetween for receiving the tongues of adjacent like safety tiles and provide an interlocking connection with said adjoining safety tiles; and

a respective through passageway provided in each tongue, running substantially parallel to said first face, and so located that the passageway in a tongue of an adjacent like tile, when the last-mentioned tongue is received in one of said gaps, aligns with the passageways of the tongues next to the said one of said gaps to permit the insertion of an elongate member through said aligned passageways to maintain the tongues associated therewith in position as regards movement normal to said first face.

The interlocking connection created between the tile and adjacent tiles by the tongues not only provides alignment but also means that the boundary line between two adjacent tiles is not a straight line running the full dimension of the tile. Instead, the boundary line meanders so that any gap between adjacent tiles is less noticeable and less likely to cause an accident. It is, however, also possible to conceal the tongues and the meander from view by providing a web of material above the tongues flush with the surface of the tile. When such a web is provided on one side of the tile and an opposite side of the tile is left free of the web, there is no difficulty in fitting two like tiles together. The provision of such a web has the advantage that would be vandals cannot see how the tiles are fitted together.

The passageways in which the elongate member is inserted serve to ensure vertical alignment of the surfaces of adjacent tiles as well as controlling the horizontal spacing between tiles but, because they distribute the connection between tiles over a relatively long length and the elongate members when inserted are surrounded by the resilient polymeric material, the construction is safer and more uniform in characteristic than when localised rigid fixings are used. Furthermore, when a paved area has been completed using safety tiles of the invention, there is no access to the elongate members except at the periphery of the paved area and that access can be prevented, for example, by means of a border strip. Thus, good resistance to vandalism is achieved.

Furthermore, the interconnection between adjacent ones of tiles of the invention is, in use, strong enough not to require fixing to the substrate. Thus, no expensive substrate preparation in order to receive fixings, such as the provision of a level concrete base, is required.

Advantageously, said impact-absorbing structure is spaced from the periphery of said layer by a border region. By that means the resiliency of the border region can be used to compensate for local effects on the safety characteristics caused by the presence of an elongate member.

Preferably, said border region has a depth of between 20 and 30 millimetres measured from the periphery of the impact-absorbing structure to the periphery of the tongues.

Advantageously, all tongues are of the same length and each passageway is provided half way between the base and the end of the associated tongue. Such an arrangement makes good use of the available material but it is also possible to locate the passageways near the end of the tongues on one side of the safety tile and to locate the passageways of tongues on an opposite side of the tile correspondingly near their bases. It is also possible to provide more than one passageway per tongue.

Advantageously, the tile is provided with a plurality of resiliently flexible elongate members, each of such diameter and length as to be insertable through respective groups of said aligned passageways to maintain the tongues associated therewith in position as regards movement normal to said first face. The use of resiliently flexible elongate members is of particular benefit in maintaining the uniformity of the safety characteristic over the whole area of the tile.

Preferably, said resiliently flexible elongate members are rods of resilient polymeric material, for example, hard rubber or plastics material, for example, nylon. Tubes of resilient material or a closely wound helical spring of metal are also possible.

The through passageways may be of oval cross-section, the long axis of the oval being substantially parallel to the said first face. Such a construction allows some relative movement of tiles in response to thermal effects causes by varying weather conditions when the elongate members are of circular cross-section.

Alternatively, said through passageways may be of circular cross-section.

The said through passageways may be oversize with respect to the diameter of said resiliently flexible elongate members. That is another means by which some relative movement of the tiles can be allowed.

The said through passageways may provide between 1 and 3 millimetres play in a direction substantially parallel to said first face. By that means, sufficient allowance for thermal effects can be provided in most circumstances but at the same time excess relative movement is prevented.

Advantageously, the said impact-absorbing structure comprises a multiplicity of walls running from said second face to said substrate-engagement face. Preferably, said walls have a thickness in the range 2 to 6 millimetres, more preferably a thickness in the range 3 to 5 millimetres. Advantageously, the said walls taper towards said substrate-engagement face. The said multiplicity of walls preferably comprises a first set of substantially parallel walls arranged cross-wise to a second set of substantially parallel walls so as to form a multiplicity of open-mouthed cells. The first and second walls may be arranged substantially at right angles so as to define substantially rectangular, for example, square cells. The sides of the square cells may each have a length in the range 25 to 35 millimetres. Such constructions are capable of providing good impact absorption with economy in the use of material.

Advantageously, some or all of said walls include short portions extending less than three quarters of the distance between said second face and said substrate-engagement face, for example, the said portions may extend between half and two thirds of said distance. Such a construction combines good impact absorption with particular economy of material.

One wall of each cell may comprise a respective one of said short portions. In the case of square cells, that distributes the short portions satisfactorily and leaves each cell with three full walls, so combining good impact absorption with economy of material.

The said safety tile may be polygonal, for example, substantially rectangular, for example, substantially square in plan.

Preferably, said tile has three or more tongues on each side.

Preferably, said tile has n tongues on each of two opposite sides of the square, and n+1 tongues on each of the other two opposite sides of the square, n being an odd number, the tongues being arranged symmetrically about the square, and the outer ones of the n+1 tongues being substantially half the width of the remaining tongues. Such a construction enables adjacent tiles to fit together with a further meander to the meandering boundary lines discussed above.

Preferably, n is equal to 3. Such a number of tongues is well suited to the size of safety tile suitable for paving a playground area.

Advantageously, each tongue has two substantially parallel sides projecting from the periphery of said layer and a distal end substantially square to the two sides. That construction enables adjacent tiles to be readily slid into place from the side, the elongate members then locking the tiles in place.

The resilient polymeric material may be rubber. PVC and polyurethane are materials which can alternatively be used.

Preferably, the resilient polymeric material has a hardness in the range 50 to 85 Shore, more preferably, a hardness in the range 65 to 80 Shore.

The tile may have a superficial area in the range 1500 to 5000 square centimetres, for example, in the range 2000 to 3000 square centimetres.

The depth of the tile, being the distance from the first face to the substrate-engagement face, may be selected from the group consisting of 40 to 50 millimetres, 60 to 70 millimetres, and 85 to 95 millimetres. Those three ranges are suitable for making safety tiles for protecting against falls from respectively, low medium and high heights of standard playground equipment.

Alternatively, the depth of the tile, being the distance from the first face to the substrate-engagement face, may be between 20 and 30 millimetres. Such a tile is very economical in the use of material and useful for laying on top of grass turf, turf itself having some ability to absorb impacts. It is also useful for paving an ordinary children's play area, not having any special equipment from which children may fall.

The said layer may have a thickness in the range 3 to 6 millimetres. That thickness combines strength and resistance to vandalism with good economy of material.

Advantageously, the body of the tile constituted by said layer, said impacting absorbing structure, and said tongues is of integral, moulded construction. In that way, the safety tile can be simply and economically manufactured.

A safety tile constructed in accordance with the invention will now be described, by way of example only, with reference to the accompanying drawings, in which:

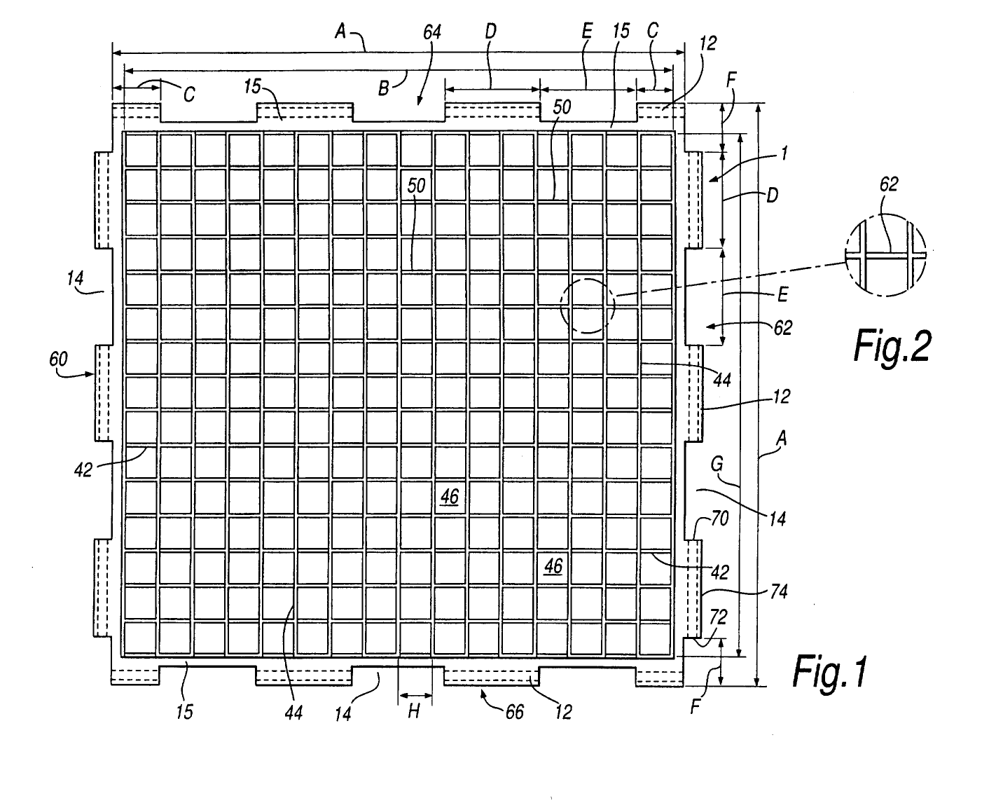

FIG. 1 is an underneath view of the safety tile;

FIG. 2 shows a detail of FIG. 1 to a slightly larger scale;

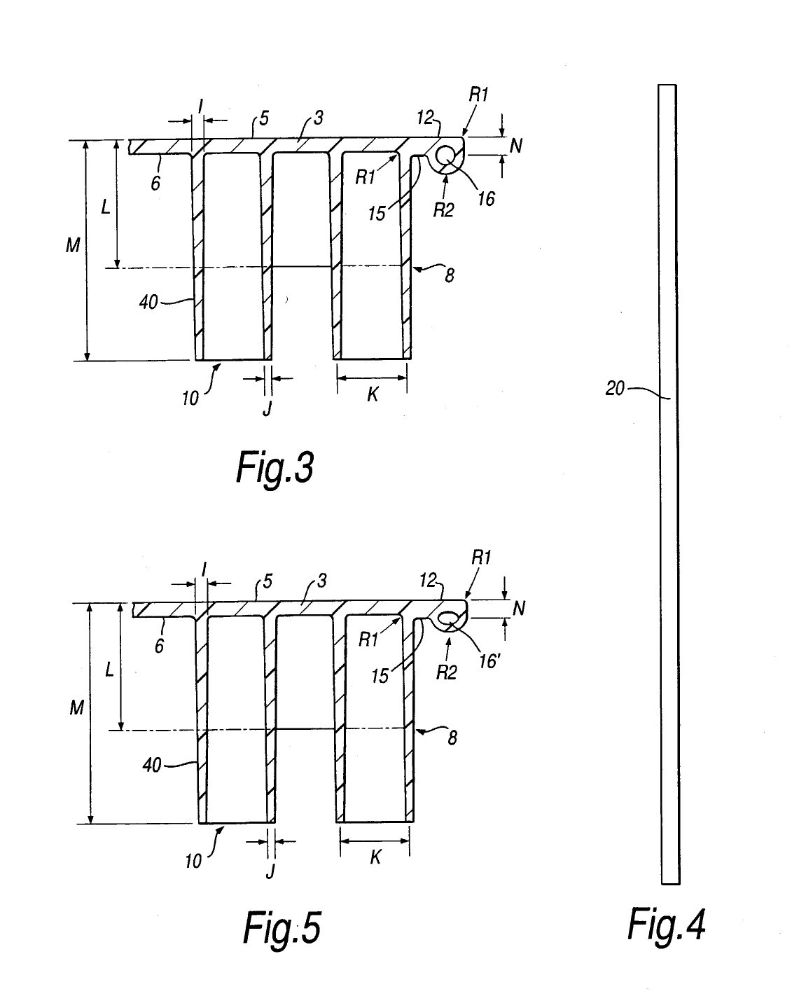

FIG. 3 shows a cross-section through a part of the safety tile in an edge region thereof;

FIG. 4 shows a resiliently flexible elongate member;

FIG. 5 shows an alternative shape of passageway; and

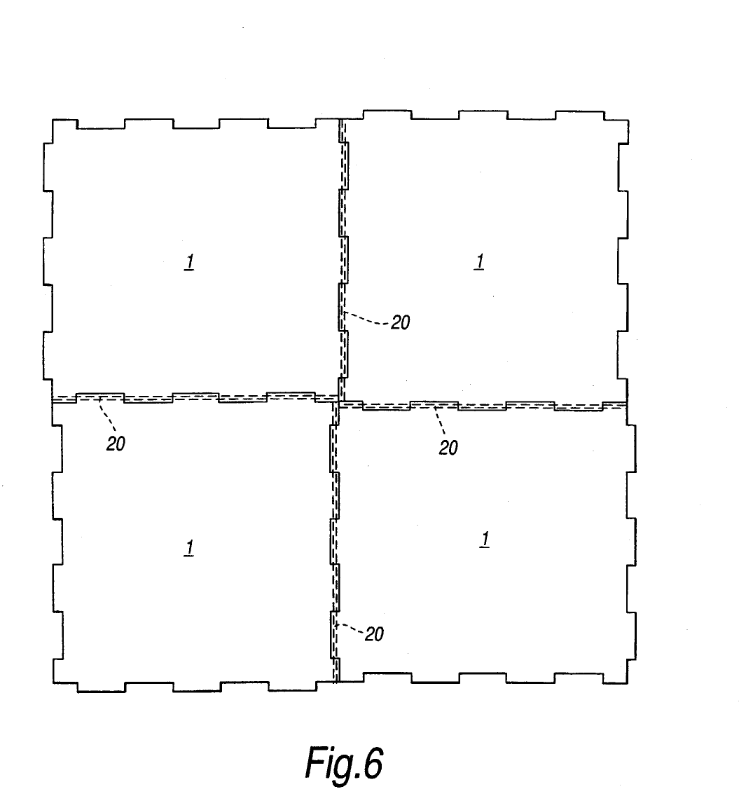

FIG. 6 is a diagrammatic plan view to a smaller scale of four safety tiles according to the invention joined together.

Referring to the accompanying drawings, a square safety tile 1 for use with other like tiles in paving a playground area, is made of a resilient polymeric material, namely rubber, and comprises a layer 3 of the polymeric material having a first face 5 defining a surface for walking on and a second, opposite, face 6. An impact-absorbing structure 8 of the polymeric material projects from the said second face 6 and terminates in a substrate-engagement face 10. A multiplicity of tongues 12 of said polymeric material project from the periphery of said layer 3, said tongues being spaced apart so as to define gaps 14 therebetween for receiving the tongues of adjacent like safety tiles and provide an interlocking connection with said adjoining safety tiles.

The impact-absorbing structure 8 is spaced from the periphery of the layer 3 by a border region 15.

The body of the tile constituted by said layer, said impacting absorbing structure, and said tongues is of integral, moulded construction.

A respective through, straight, passageway 16 of circular cross-section is provided in each tongue 12 and runs substantially parallel to said first face, and is so located that the passageway in a tongue of an adjacent like tile, when the last-mentioned tongue is received in one of said gaps 14, aligns with the passageways of the tongues next to the said one of said gaps.

Resiliently flexible elongate members 20, of which one is shown in FIG. 4, are provided and have such diameter and length as to be insertable through said aligned passageways 16 to maintain the tongues associated therewith in position as regards movement normal to said first face (vertical movement of the laid tile).

All the tongues 12 are of the same length and each passageway 16 is provided half way between the base and the end of the associated tongue.

The resiliently flexible elongate members 20 are rods made of nylon.

The through passageways 16 are oversize with respect to the diameter of said resiliently flexible elongate members 20 and provide between 1 and 3 millimetres play in a direction substantially parallel to said first face 5.

The impact-absorbing structure 8 comprises a multiplicity of walls 40 running from said second face 6 to said substrate-engagement face 10 and tapering towards said substrate-engagement face (the face is actually a plane defined by the ends of the walls). The multiplicity of walls comprises a first set of substantially parallel walls 42 arranged cross-wise at right angles to a second set of substantially parallel walls 44 so as to form a multiplicity of open-mouthed square cells 46. In the example illustrated in FIG. 1, there are sixteen columns and fifteen rows of cells 46.

All the walls 42 of one set include short portions extending just over half the distance between said second face and said substrate-engagement face 10. That is to be seen from FIG. 1 and the dot-dash line 48 in FIG. 3.

One wall 50 of each cell 46 comprises a respective one of said short portions.

The tile has three tongues 12 on each of two opposite sides 60, 62 of the square, and four tongues on each of the other two opposite sides 64, 66 of the square. The tongues are arranged symmetrically about the square, and the outer ones of the four tongues are substantially half the width of the remaining tongues.

Each tongue 12 has two substantially parallel sides 70, 72 projecting from the periphery of said layer 3 and a distal end 74 substantially square to the two sides.

The rubber of the safety tile 1 has a hardness of about 70 Shore.

A particular example of the safety tile 1 had the following dimensions in millimetres for the lengths identified in FIG. 1:

| | |
|---|---|
| A | 500 |
| B | 480 |
| C | 41 |
| D | 83 |
| E | 84 |
| F | 41.5 |
| G | 450 |
| H | 30 |
| I | 5 |
| J | 3 |
| K | 30 |
| L | 50 |
| M | 90 |
| N | 8 |

The radii R1 were 1.5 millimetres and the radius R2 was 8 millimetres. The passageway 16 had a diameter of 8 millimetres. The nylon rods 20 had a diameter of 6 millimetres and had a length somewhat less than a side of the safety tile so that the ends of the rods did not foul each other when inserted into the passageways 16. All the rods 20 were of the same length but rods of two slightly different lengths could have been used.

The above dimensions were intended for a tile for use under the highest equipment normally provided in playgrounds. The dimensions L (the length of the short wall portions from the top surface of the tile) and M (the overall depth of the tile) were changed as follows for making tiles for use under equipment of medium and low height, the remaining dimensions being unchanged:

medium

| | |
|---|---|
| L | 40 |
| M | 65 |

low

| | |
|---|---|
| L | 25 |
| M | 45 |

In an example of the tile for laying on grass turf, the overall depth of the tile M was 25 millimetres.

FIG. 5 shows a modification in which the said through passageways 16 of circular cross-section are replaced by passageways 16′ of oval cross-section.

FIG. 6 is a plan view of four safety tiles according to the invention fitted together, the rods 20 inserted to hold the tiles together being shown in dotted outline. It is to be noted that the meandering boundary line between two adjacent tiles undergoes a further meander or shift when it passes into the next pair of adjacent tiles.

A desired area of paving is completed by adding further tiles in a similar manner and the periphery is then closed off by means of a boundary strip (not shown). If desired, the whole paved area can be sunk so that its top surface is level with the surrounding ground. Alternatively, a transitional ramp leading to the top surface of the tiles can be provided.

Other shapes of resiliently flexible elongate members could be used instead of those described. For example, the elongate members could be of oval section or the passageways and elongate members could both have a rectangular or square section.

1. A safety tile for use with other like tiles in paving a playground area, the tile being made of a resilient polymeric material and comprising:
a layer of the polymeric material having a first face defining a surface for walking on and a second, opposite, face;
an impact-absorbing structure of the polymeric material projecting from the said second face and terminating in a substrate-engagement face;
a multiplicity of tongues of said polymeric material projecting from the periphery of said layer, said tongues being spaced apart so as to define gaps therebetween for receiving the tongues of adjacent like safety tiles and provide an interlocking connection with said adjoining safety tiles; and
a respective through passageway provided in each tongue, running substantially parallel to said first face, and so located that the passageway in a tongue of an adjacent like tile, when the last-mentioned tongue is received in one of said gaps, aligns with the passageways of the tongues next to the said one of said gaps to permit the insertion of an elongate member through said aligned passageways to maintain the tongues associated therewith in position as regards movement normal to said first face.

2. A safety tile as claimed in claim 1, wherein said impact-absorbing structure is spaced from the periphery of said layer by a border region.

3. A safety tile as claimed in claim 2, wherein said border region has a depth of between 20 and 30 millimetres measured from the periphery of the impact-absorbing structure to the periphery of the tongues.

4. A safety tile as claimed in any preceding claim, wherein all tongues are of the same length and each passageway is provided half way between the base and the end of the associated tongue.

5. A safety tile as claimed in any preceding claim, the tile being provided with a plurality of resiliently flexible elongate members, each of such diameter and length as to be insertable through respective groups of said aligned passageways to maintain the tongues associated therewith in position as regards movement normal to said first face.

6. A safety tile as claimed in claim 5, wherein said resiliently flexible elongate members are rods of resilient polymeric material.

7. A safety tile as claimed in claim 6, wherein said rods are made of rubber.

8. A safety tile as claimed in claim 6, wherein said rods are made of a plastics material.

9. A safety tile as claimed in claim 8, wherein said rods are made of nylon.

10. A safety tile as claimed in any preceding claim, wherein said through passageways are of oval cross-section, the long axis of the oval being substantially parallel to the said first face.

11. A safety tile as claimed in any preceding claim, wherein said through passageways are of circular cross-section.

12. A safety tile as claimed in claim 5 or claim 6 or any of claims 7 to 11 when dependent on claim 5, wherein said through passageways are oversize with respect to the diameter of said resiliently flexible elongate members.

13. A safety tile as claimed in claim 12, wherein said through passageways provide between 1 and 3 millimetres play in a direction substantially parallel to said first face.

14. A safety tile as claimed in any preceding claim, wherein said impact-absorbing structure comprises a multiplicity of walls running from said second face to said substrate-engagement face.

15. A safety tile as claimed in claim 14, wherein said walls have a thickness in the range 2 to 6 millimetres.

16. A safety tile as claimed in claim 15, wherein said walls have a thickness in the range 3 to 5 millimetres.

17. A safety tile as claimed in of claims 14 to 16, wherein said walls taper towards said substrate-engagement face.

18. A safety tile as claimed in any of claims 14 to 17, wherein said multiplicity of walls comprises a first set of substantially parallel walls arranged cross-wise to a second set of substantially parallel walls so as to form a multiplicity of open-mouthed cells.

19. A safety tile as claimed in claim 18, wherein the first and second walls are arranged substantially at right angles so as to define substantially rectangular cells.

20. A safety tile as claimed in claim 19, wherein the cells are square.

21. A safety tile as claimed in claim 20, wherein the side of the square cells each have a length in the range 25 to 35 millimetres.

22. A safety tile as claimed in any one of claims 14 to 21, wherein some or all of said walls include short portions extending less than three quarters of the distance between said second face and said substrate-engagement face.

23. A safety tile as claimed in claim 22, wherein said portions extend between half and two thirds of said distance.

24. A safety tile as claimed in claim 22 or claim 23 when dependent on claim 19 or claim 20, wherein one wall of each cell comprises a respective one of said short portions.

25. A safety tile as claimed in any preceding claim, wherein said safety tile is polygonal in plan.

26. A safety tile as claimed in claim 25, wherein said safety tile is substantially rectangular in plan.

27. A safety tile as claim in claim 26, wherein said tile is substantially square in plan.

28. A safety tile as claimed in claim 26 or claim 27, wherein said tile has three or more tongues on each side.

29. A safety tile as claimed in claim 27 or claim 28, wherein said tile has n tongues on each of two opposite sides of the square, and n+1 tongues on each of the other two opposite sides of the square, n being an odd number, the tongues being arranged symmetrically about the square, and the outer ones of the n+1 tongues being substantially half the width of the remaining tongues.

30. A safety tile as claimed in claim 29, wherein n is equal to 3.

31. A safety tile as claimed in any preceding claim, wherein each tongue has two substantially parallel sides projecting from the periphery of said layer and a distal end substantially square to the two sides.

32. A safety tile as claimed in any preceding claim, wherein the resilient polymeric material is rubber.

33. A safety tile as claimed in any preceding claim, wherein the resilient polymeric material has a hardness in the range 50 to 85 Shore.

34. A safety tile as claimed in claim 33, wherein the resilient polymeric material has a hardness in the range 65 to 80 Shore.

35. A safety tile as claimed in any preceding claim, wherein the tile has a superficial area in the range 1500 to 5000 square centimetres.

36. A safety tile as claimed in claim 35, wherein the tile has superficial area in the range 2000 to 3000 square centimetres.

37. A safety tile as claimed in any preceding claim wherein the depth of the tile, being the distance from the first face to the substrate-engagement face, is selected from the group consisting of 40 to 50 millimetres, 60 to 70 millimetres, and 85 to 95 millimetres.

38. A safety tile as claimed in any of claims 1 to 36, wherein the depth of the tile, being the distance from the first face to the substrate-engagement face, is between 20 and 30 millimetres.

39. A safety tile as claimed in any preceding claim, wherein the said layer has a thickness in the range 3 to 6 millimetres.

40. A safety tile as claimed in any preceding claim, wherein the body of the tile constituted by said layer, said impacting absorbing structure, and said tongues is of integral, moulded construction.

41. A safety tile substantially as herein described with reference to, and as illustrated by, the accompanying drawings.
